(19) United States
(12) Patent Application Publication
(10) Pub. No.: US 2002/0069371 A1
(43) Pub. Date: Jun. 6, 2002

(54) Methods and apparatus for shutdown of computers served by a single uninterruptible power supply

(76) Inventor: John Teeling, Mesa, AZ (US)

Correspondence Address: Laura J. Zeman, SNELL & WILMER L.L.P., One Arizona Center, 400 East Van Buren, Phoenix, AZ, 85004-2202, US

(21) Appl. No.: 09/728,841

(22) Filed: Dec. 4, 2000

(51) Int. Cl. G06F 1/26

(52) U.S. Cl. 713/300

(57) ABSTRACT

The present invention includes a UPS (uninterruptible power supply) system for facilitating communication between a UPS and a number of computers. If a power malfunction occurs in the UPS system, the UPS notifies a controller instructing of the power malfunction. A timing recovery circuit verifies the legitimacy of the power malfunction. In this manner, the timing recovery circuit checks to ensure an actual power malfunction has occurred, guards against improper UPS power malfunction signals, and other UPS malfunction. Upon verification, the controller then notifies each of the computers to prepare for shutdown. The controller may notify each of the computer of the power malfunction in parallel. Once the computers have prepared for shutdown, each computer sends a return signal to the controller. The controller synchronizes the return signals and notifies the UPS to shutdown the UPS system upon receiving instruction from all of the computers.

### BACKGROUND OF THE INVENTION

The present invention generally relates to shutdown of a computer served by a UPS (uninterruptible power supply) and methods for its use. More particularly, the present invention relates to shutdown of more than one computer served by a single shared UPS and methods for its use.

Many computers operate using a UPS to provide power to the computer for a short time after a loss of AC line power. A UPS allows the computer to gracefully prepare for shutdown (e.g., terminate its application, store data on its hard drive or other media, and other procedures). If a loss of AC line power occurs, the UPS communicates the power loss to the computer via a designated serial port on the computer. Once the computer has finished its shutdown procedure, the computer communicates a return signal to the UPS signaling completion of its shutdown procedure.

Typically, one UPS serves only one computer. However, even in the case of a network (e.g., an industrial computer chassis) or system of computers, for example, having several computers, there is still only one UPS serving all the computers. In this manner, the UPS has only one port to communicate a power failure to all the computers in the system. In addition, the UPS must receive a return signal from at least one computer in order to determine when to shutdown without leaving the computer in a partial shutdown mode, operating at a lower than normal voltage, and/or draining the batteries. However, as is often the case, one computer sends a return signal for shutdown before one or more of the remaining computers have finished preparing for shutdown. As such, the single UPS will shutdown upon receiving the first return signal without knowing whether the remaining computers have completed preparations for shutdown. This situation could cause improper shutdown, loss of data, or other complications for the computers not yet prepared to shutdown. Thus, it is highly desirable to synchronize the return signals from the various computers served by the single UPS in order to allow for proper shutdown of all the computers before the UPS shuts down the system.

### SUMMARY OF THE INVENTION

The present invention provides methods and apparatus for shutdown of a number of computers by supplying a single UPS (uninterruptible power supply) for the computers, and splitting a power malfunction signal from the UPS to allow communication of the power malfunction signal to the computers. As such, the computers receive the power malfunction signal from the UPS in parallel. Once the computers receive the power malfunction signal from the UPS, each computer sends a return signal to the UPS upon completion of preparation for shutdown. The return signals from the computers are synchronized before a shutdown signal is sent to the UPS instructing shutdown of the system. Thus, by synchronizing the return signals, the present invention substantially prevents premature shutdown of the system.

### BRIEF DESCRIPTION OF THE DRAWING FIGURES

The subject invention will hereinafter be described in the context of the appended drawing figures, wherein like numerals denote like elements, and:

FIG. 1 illustrates a UPS system in accordance with an exemplary embodiment of the present invention;

FIG. 2 illustrates a UPS system in accordance with an exemplary embodiment of the present invention; and

FIG. 3 illustrates a method for facilitating communication between a UPS and one or more computers in accordance with an exemplary embodiment of the present invention.

### DETAILED DESCRIPTION

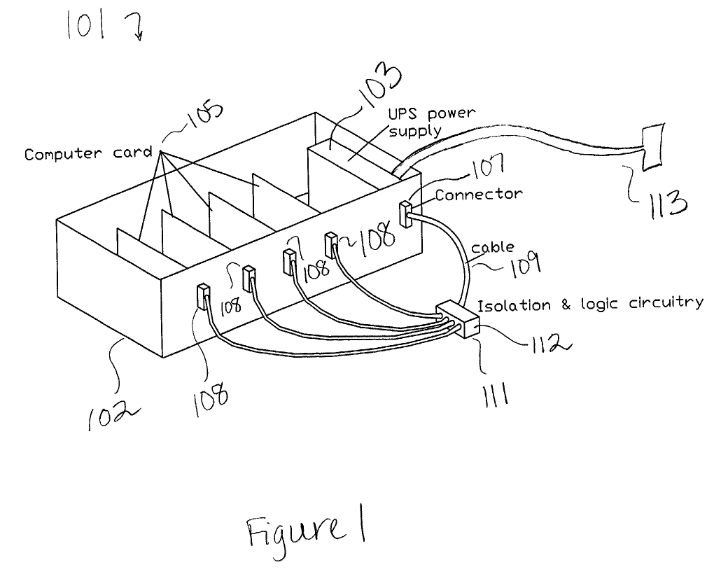

The present invention improves communication between any number of computers and a single UPS (uninterruptible power supply). FIG. 1 illustrates a UPS system 101 in accordance with an exemplary embodiment of the present invention. Generally, a UPS system includes one or more UPS power supplies, one or more computers, and a medium of communication between the UPS(s) and the computer(s). UPS system 101 includes a single UPS 103, a number of computer cards 105, controller 111, and a primary power supply 113. UPS 103 is coupled to controller 111 via a cable 109 and a connector 107. Cable 109 and connector 107 may be any conventional cable or connector (e.g., DB-9 electrical connector) commonly used in UPS systems, computer systems, networks, and the like. UPS 103, computer cards 105, and/or controller 111 may be housed in one or more chasses, together or separately. For example, UPS 103 and/or computer cards 105 may be housed in one chassis 102, and controller 111 may be housed in another chassis 112. Various connectors 107 and 108 provide a medium of communication between UPS 103, computer cards 105, and controller 111. In addition, primary power supply 113 may be any commonly used power supply (e.g., AC power line, DC power line, or the like).

If a power malfunction occurs in primary power supply 113, UPS 103 notifies controller 111 instructing of the power malfunction via a power malfunction signal. A power malfunction may include loss of AC line power, DC line power, noise, or spurious signals. In this manner, controller 111 may then notify each of computer cards 105 (e.g., via a designated serial port) to prepare for shutdown via the power malfunction signal. Controller 111 may notify computer cards 105 in parallel, even though there may be a serial connection from UPS 103 to controller 111. In addition, controller 111 will notify UP S 103 to shutdown UPS system 101 upon receiving instruction from all of computer cards 105. The various notifications may be via signals, commands, instructions, and/or the like. For example, the various notifications may be via a software program used in conjunction with controller 111 configured as a microprocessor.

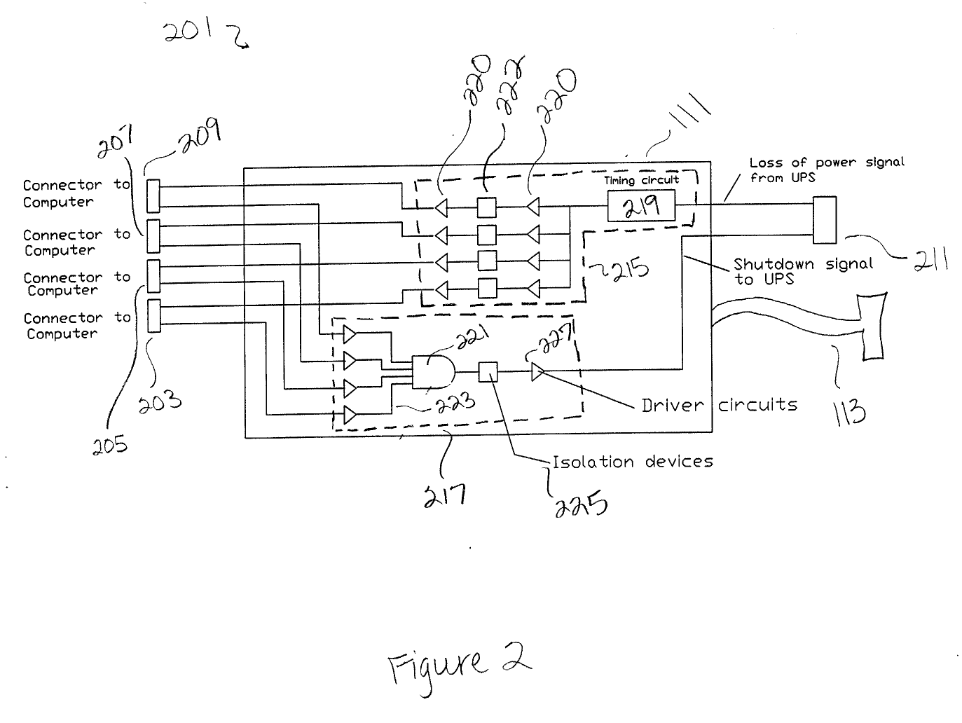

In order to better understand the operation of controller 111, a UPS system 201 is illustrated in FIG. 2 in accordance with an exemplary embodiment of the present invention. UPS system 201 includes controller 111 coupled between a UPS 211 and a number of computers 203, 205, 207, and 209. Number of computers 203, 205, 207, and 209 may include any number of computers, and are illustrated as four computers for purposes of simplicity. UPS system 201 includes primary power supply 113. Controller 111 may include a timing recovery circuit 215 coupled between UPS 211 and one or more of computers 203, 205, 207, and 209. Controller 111 may also include return controller 217 coupled between UPS 211 and one or more of computers 203, 205, 207, and 209.

Alternatively, controller 111 may be coupled to computers 203, 205, 207, and 209 without the use of timing recovery circuit 215 and return controller 217. In such an alternative embodiment, controller 111 may split the power malfunction signal from UPS 211 to computers 203, 205, 207, and 209 in parallel without the use of timing recovery circuit 215. Cables, wires, or another medium may be used to physically split the power malfunction signal from UPS 211 to computers 203, 205, 207, and 209. For example, a serial-to-parallel converter along with an isolation means (e.g., optical means, transformer means, electromechanical device, and/or the like) may split the power malfunction signal from UPS 211 to computers 203, 205, 207, and 209. Thus, controller 111 may split the power malfunction signal from UPS 211 to computers 203, 205, 207, and 209 in parallel.

UPS system 201 operates similar to UPS system 101 of FIG. 1. If a power malfunction occurs in primary power supply 113, UPS 211 notifies controller 111 instructing of the power malfunction via a power malfunction signal. UPS 211 may notify controller 111 of the power malfunction via timing recovery circuit 215, or alternatively via another medium of communication. Timing recovery circuit 215 includes timing circuit 219 and various drivers 220 and various isolation devices 222. Timing circuit 219 verifies that the legitimacy of the power malfunction. In this manner, timing circuit 219 checks to ensure an actual power malfunction has occurred, guards against improper or inappropriate UPS 211 power malfunction signals (e.g., false power malfunction), other UPS malfunction, and the like. Timing circuit 219 may include a timer to delay notification of a power malfunction to computer 203, 205, 207, and 209. In addition, timing circuit 219 may use an intelligent sampling of power malfunction notifications from UPS 211 to determine whether an actual power malfunction has occurred. For example, timing circuit 219 may include a microcomputer having an algorithm (e.g., commands, instructions, software, etc.) to perform analysis and control functions (e.g., timing delays, verification checks, etc.) in order to determine the validity of the power malfunction notification. As such, timing recovery circuit 215 may include an intelligent device (e.g., microprocessor) using custom power monitor software geared toward the needs of UPS system 201. Also, timing circuit 219 may include one or more noise filters (e.g. low pass filter) in order to filter out noise and/or spurious signals. One embodiment of timing circuit 219 may be a Motorola® MC14490 device.

Drivers 220 (e.g., line drivers) drive isolation devices 222 (e.g., electrical, electromechanical, or optical isolation devices). For example, drivers 220 may drive (e.g., translate or shift) the logic circuit levels for each of computers 203, 205, 207, and 209. Drivers 220 may be any number of drivers including one or more. In addition, isolation devices 222 help prevent interference between adjacent components. For example, isolation devices 222 may prevent electrical interference by using light coupling signals (e.g., opto-isolators) among adjacent components. Isolation devices 222 may be any number of devices including one or more.

Once one or more of computers 203, 205, 207, and 209 receive the power malfunction signal from UPS 211, each of computers 203, 205, 207, and 209 prepare to shutdown. Preparation for shutdown may include a number of procedures depending on the computer and the applications the computer houses. Upon completion of preparation for shutdown, each of computers 203, 205, 207, and 209 notify return controller 217. Upon notification from one or more of computers 203, 205, 207, and 209, return controller 217 determines whether all of computers 203, 205, 207, and 209 have prepared for shutdown. If one or more of computers 203, 205, 207, and 209 have not completed preparation for shutdown, then return controller 217 will not notify UPS 211 to shutdown UPS system 201. On the other hand, if all of computers 203, 205, 207, and 209 have completed preparation for shutdown, then return controller 217 instructs UPS 211 to shutdown UPS system 201. Alternatively, controller 217 may be programmed or configured to instruct UPS 211 to shutdown UPS system 201 upon completion of preparation for shutdown of any number of computers 203, 205, 207, and 209. In this manner, return controller 217 waits to receive confirmation (and/or instruction) from computers 203, 205, 207, and 209 before requesting that UPS 211 shutdown UPS system 201.

In one exemplary embodiment of the present invention, return controller 217 may include a logical AND circuit 221, which receives instructions from computers 203, 205, 207, and 209. Logical AND circuit 221 may be an integrated circuit, relays, software, and/or the like. Once computers 203, 205, 207, and 209 have completed preparation for shutdown, each of computers 203, 205, 207, and 209 send logical AND circuit 221 a return signal indicating completion. For example, once computers 203, 205, 207, and 209 have completed preparation for shutdown, each of computers 203, 205, 207, and 209 send logical AND circuit 221 a digital “1” to indicate completion. Once logical AND circuit 221 receives digital “is” from all of computers 203, 205, 207, and 209, logical AND circuit 221 outputs a logical “1”indicating completion. In this manner, return controller 217 synchronizes the return signals from computers 203, 205, 207, and 209 to UPS 211. At this point, controller 217 instructs UPS 211 to shutdown UPS system 201. In one exemplary embodiment of the present invention, controller 217 instructs UPS 211 to shutdown UPS system 201 only when all of computers 203, 205, 207, and 209 have completed preparation for shutdown. Shutdown of UPS system 201 may include turning off UPS 211, removing power from computers 203, 205, 207, and 209, and/or the like.

Controller 217 may also include one or more isolation devices 225, which are similar to one or more of isolation devices 222. In addition, controller 217 may include one or more drivers 227, which are similar to one or more drivers 220. Controller 111 may operate without timing recovery circuit 215 or return controller 217; however, various exemplary embodiments are illustrated.

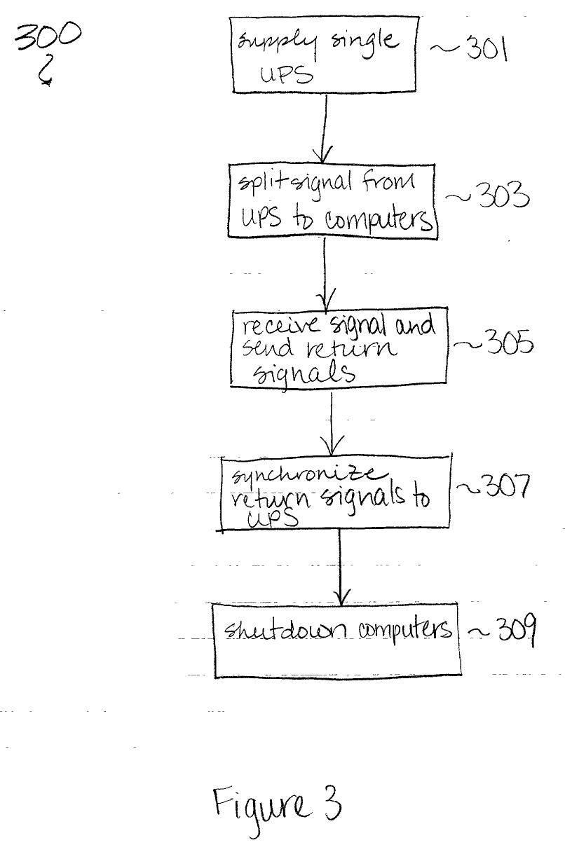

The flowchart 300 of FIG. 3 illustrates a method for facilitating communication between UPS 211 and one or more of computers 203, 205, 207, and 209 in accordance with an exemplary embodiment of the present invention. The method of flowchart 300 includes supplying UPS 211 for computers 203, 205, 207, and 209 (step 301). The method also includes splitting a power malfunction signal from UPS 211 to allow communication of the power malfunction signal in parallel to computers 203, 205, 207, and 209 (step 303). Timing recovery circuit 215 may help in guarding against inappropriate or improper UPS 211 power malfunction signals to computers 203, 205, 207, and 209. Also, the power malfunction signal may be communicated in parallel from UPS 211 to computers 203, 205, 207, and 209, and received in parallel at computers 203, 205, 207, and 209.

Once splitting of the power malfunction signal from UPS 211 to computers 203, 205, 207, and 209 occurs, the power malfunction signal is received at computers 203, 205, 207, and 209 and a return signal is provided from each of computers 203, 205, 207, and 209 (step 305). The method further includes synchronizing the return signals from computers 203, 205, 207, and 209 to UPS 211 (step 307). For example, synchronizing the return signals from computers 203, 205, 207, and 209 to UPS 211 may be via logical AND circuit 221. Once computers 203, 205, 207, and 209 have completed preparation for shutdown, each of computers 203, 205, 207, and 209 send a return signal to UPS 211. For example, each of computers 203, 205, 207, and 209 may send a return signal to logical AND circuit 221 upon completion of preparation for shutdown. The method also includes shutting down computers 203, 205, 207, and 209 upon receiving return signals from computers 203, 205, 207, and 209 at UPS 211 (step 309). For example, a shutdown signal may be generated from computers 203, 205, 207, and 209 to UPS 211 only when each of the return signals from each of computers 203, 205, 207, and 209 indicates completion of preparation for shutdown. Alternatively, logical AND circuit 221 may be configured such that a shutdown signal may be generated from computers 203, 205, 207, and 209 to UPS 211 when any number of return signals from each of computers 203, 205, 207, and 209 indicates completion of preparation for shutdown.

Thus, the present invention provides methods and apparatus for shutdown of one or more computers served by a UPS. In an exemplary embodiment of the present invention, the UPS and the various computers communicate via a controller. The controller may split a power malfunction signal from the UPS to the various computers in order to communicate the power malfunction signal in parallel. In addition, the controller may synchronize return signals from the various computers before instructing the UPS to shutdown the system. Thus, the present invention improves communication between the UPS and the various computers in order to provide a more graceful shutdown of a UPS system.

Although the invention has been described herein with reference to the appended drawing figures, it will be appreciated that the scope of the invention is not so limited. Various modifications in the design and implementation of various components and method steps discussed herein may be made without departing from the spirit and scope of the invention, as set forth in the appended claims. No element described herein is necessary for the practice of the invention, unless the element is expressly described herein as “essential” or “required”. Steps recited in any method claims may be executed in any order.

What is claimed is:

1. A method for shutdown of a plurality of computers, comprising the steps of:
supplying a single uninterruptible power supply to the plurality of computers; and
splitting a power malfunction signal from the single uninterruptible power supply to allow communication of the power malfunction signal in parallel to the plurality of computers in order to facilitate shutdown of the plurality of computers.

2. The method of claim 1, further comprising the steps of:
receiving the power malfunction signal at the plurality of computers;
providing a plurality of return signals from the plurality of computers, wherein each computer has one return signal; and
synchronizing the plurality of return signals from the plurality of computers to the single uninterruptible power supply.

3. The method of claim 2, further comprising the step of synchronizing the plurality of return signals from the plurality of computers to the single uninterruptible power supply via a logical AND circuit.

4. The method of claim 2, further comprising the step of shutting down the plurality of computers after receiving at least one of the plurality of return signals from the plurality of computers at the single uninterruptible power supply.

5. The method of claim 1, further comprising the step of guarding against inappropriate uninterruptible power supply power malfunction signals to the plurality of computers via a timing recovery circuit.

6. The method of claim 1, further comprising the steps of:
receiving the power malfunction signal at the plurality of computers;
providing a plurality of return signals from the plurality of computers, wherein each computer has one return signal;
synchronizing the plurality of return signals from the plurality of computers to the single uninterruptible power supply; and
shutting down the plurality of computers only after receiving the plurality of return signals from the plurality of computers at the single uninterruptible power supply.

7. A method of shutdown of a plurality of computers, comprising the steps of:
supplying a single uninterruptible power supply for the plurality of computers;
splitting a power malfunction signal from the single uninterruptible power supply to the plurality of computers; and
communicating in parallel the power malfunction signal from the single uninterruptible power supply to the plurality of computers.

8. The method of claim 7, further comprising the steps of:
receiving the power malfunction signal in parallel at the plurality of computers; and
sending a return signal from each of the plurality of computers to the single uninterruptible power supply upon completion of preparation for shutdown.

9. The method of claim 8, further comprising the step of shutting down the plurality of computers upon receiving the return signals from the plurality of computers at the single uninterruptible power supply.

10. The method of claim 8, further comprising the step of generating a shutdown signal from the plurality of computers to the single uninterruptible power supply only when each of the return signals from the plurality of computers indicates completion of preparation for shutdown.

11. The method of claim 7, further comprising the steps of:
sending a return signal from each of the plurality of computers to a logical AND circuit upon completion of preparation for shutdown; and
generating a shutdown signal from the plurality of computers upon completion of preparation for shutdown of each of the plurality of computers.

12. The method of claim 7, further comprising the steps of:
receiving the power malfunction signal in parallel at the plurality of computers;
sending a return signal from each of the plurality of computers to the single uninterruptible power supply upon completion of preparation for shutdown; and
shutting down the plurality of computers upon receiving the return signals from the plurality of computers at the single uninterruptible power supply.

13. An apparatus for shutdown of a plurality of computers, comprising:
a uninterruptible power supply; and
a controller coupled between the uninterruptible power supply and the plurality of computers for splitting a power malfunction signal in parallel from the single uninterruptible power supply to the plurality of computers.

14. The apparatus of claim 13, wherein the controller receives a return signal from each of the plurality of computers upon completion of preparation for shutdown.

15. The apparatus of claim 14, wherein:
the controller synchronizes the return signals from the plurality of computers; and
the controller sends a shutdown signal to the uninterruptible power supply when the plurality of computers has completed preparation for shutdown.

16. The apparatus of claim 13, further comprising a timing recovery circuit coupled between the uninterruptible power supply and the plurality of computers that checks for improper power malfunction signals from the uninterruptible power supply.

17. The apparatus of claim 16, further comprising a noise filter coupled between the uninterruptible power supply and the plurality of computers for filtering the improper power malfunction signals from the uninterruptible power supply.

18. The apparatus of claim 16, wherein:
the timing recovery circuit includes a microcomputer for validating the power malfunction signal from the uninterruptible power supply; and
the microcomputer includes a timing delay between the uninterruptible power supply and the plurality of computers.

19. The apparatus of claim 13, wherein:
the controller receives a return signal from each of the plurality of computers upon completion of preparation for shutdown;
the controller synchronizes the return signals from the plurality of computers; and
the controller sends a shutdown signal to the uninterruptible power supply only when all the plurality of computers has completed preparation for shutdown.
